(19) United States
(12) Patent Application Publication
(10) Pub. No.: US 2023/0065125 A1
(43) Pub. Date: Mar. 2, 2023

(54) ESTIMATION APPARATUS, METHOD, AND PROGRAM

(71) Applicant: NIPPON TELEGRAPH AND TELEPHONE CORPORATION, Tokyo (JP)

(72) Inventors: Naoto ABE, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 17/800,178

(22) PCT Filed: Feb. 18, 2020
(86) PCT No.: PCT/JP2020/006193

§ 371 Date: Aug. 16, 2022

(51) Int. Cl. G06V 10/74

(52) U.S. Cl. CPC G06V 10/761; G06V 2201/07

(57) ABSTRACT

An estimation apparatus according to an embodiment includes: an acquisition unit configured to acquire first information indicating that an event is occurring at a location, along with a type of the event, second information indicating whether the first information is third information determined by a user or fourth information detected by a sensor, and accuracy indicating certainty of the third or fourth information; a first estimation unit configured to estimate a probability that a predetermined event is actually occurring, based on accuracy of the third information determined by the user, a frequency of occurrence of the third information, accuracy of the fourth information detected by the sensor, and a frequency of occurrence of the fourth information, acquired by the acquisition unit; and a second estimation unit configured to estimate whether or not the predetermined event is actually occurring based on the probability estimated by the first estimation unit and a threshold value.

### TECHNICAL FIELD

Embodiments of the present invention relate to an estimation apparatus, a method, and a program.

### BACKGROUND ART

With the widespread use of mobile terminals (mobile devices) such as smartphones, photography and posting have become easier.

In the conventional technology, for example, for daily administrative tasks of local municipalities, there are attempts to apply participatory sensing that enables information to be acquired in real time via mobile terminals owned by city officers, and enable efficient information collection and sharing (for example, see NPL 1).
In cloud sensing where smartphones and devices mounted on vehicles utilized by participants to the service are used as sensors and play a role for the collection of data, there are attempts to help solve social issues such as tourism policies such as creating liveliness, disaster prevention, crime prevention, and the like by reciting citizen participation and collecting environmental sound of the city by smartphones (see, for example, NPL 2).

In addition, there are attempts to collect information by assigning tasks to people who participate in information collection work.

### CITATION LIST

### Non Patent Literature

NPL 1: Takuro Yonezawa, et al., “Improvement of municipal administration works and city understandings by participatory sensing with city officers”, DICOMO2018, pp. 320-329

NPL 2: Msanobu Abe, Noboru Sonehara, “Cloud Sensing Helping Social Problem Resolution”, NII Today No. 70, 2015, pp. 8-9 https://www.nii.ac.jp/about/upload/NII70_web.pdf

### SUMMARY OF THE INVENTION

### Technical Problem

In the approach as described above, tasks are assigned to the users who participate in the information collection work, and information is collected from mobile bodies owned by the users, such as smartphones and in-vehicle devices, for example.

However, with the approach as described above, information cannot be obtained from users who do not participate in the information collection work, or there has not been considered a mechanism to integrate this information with information from users who do not participate in the information collection work when information is obtained from moving bodies owned by the users who do not participate in the information collection work.

The present invention has been made in view of the above circumstances, and an object of the present invention is to provide an estimation apparatus, a method, and a program capable of appropriately estimating that a predetermined event is occurring.

### Means for Solving the Problem

According to an aspect of the present invention, an estimation apparatus includes: an acquisition unit configured to acquire first information indicating that an event is occurring at a location, along with a type of the event, second information indicating whether the first information is third information determined by a user or fourth information detected by a sensor, and accuracy indicating certainty of the third or fourth information; a first estimation unit configured to estimate a probability that a predetermined event is actually occurring, based on accuracy of the third information determined by the user, a frequency of occurrence of the third information, accuracy of the fourth information detected by the sensor, and a frequency of occurrence of the fourth information, acquired by the acquisition unit; and a second estimation unit configured to estimate whether or not the predetermined event is actually occurring based on the probability estimated by the first estimation unit and a threshold value.

According to an aspect of the present invention, an estimation method performed by an estimation apparatus includes: acquiring first information indicating that an event is occurring at a location, along with a type of the event, second information indicating whether the first information is third information determined by a user or fourth information detected by a sensor, and accuracy indicating certainty of the third or fourth information; estimating a probability that a predetermined event is actually occurring, based on accuracy of the third information determined by the user, a frequency of occurrence of the third information, accuracy of the fourth information detected by the sensor, and a frequency of occurrence of the fourth information acquired; and estimating whether or not the predetermined event is actually occurring based on the probability estimated and a threshold value.

### Effects of the Invention

According to the present invention, it is possible to appropriately estimate that a predetermined event is occurring.

### BRIEF DESCRIPTION OF DRAWINGS

FIG. 1 is a diagram illustrating an application example of a data processing apparatus according to an embodiment of the present invention.

FIG. 2 is a flow chart illustrating an example of operation by the data processing apparatus.

FIG. 3 is a diagram illustrating an example of accuracy and frequency of post information by category in a table format.

FIG. 4 is a diagram illustrating an example of accuracy and frequency of sensing information by category in a table format.

FIG. 5 is a diagram illustrating an example of a probability of occurrence of each event in a table format.

FIG. 6 is a diagram illustrating an example of collection results of information related to a link in a table format.

FIG. 7 is a diagram illustrating an example of correction of accuracy based on post information in collection results related to a link in a table format.

FIG. 8 is a diagram illustrating an example of correction of accuracy based on post information and sensing information in collection results related to a link in a table format.

FIG. 9 is a diagram illustrating an example of correction of accuracy based on sensing information in collection results related to a link in a table format.

FIG. 10 is a block diagram illustrating an example of a hardware configuration of a data processing apparatus according to an embodiment of the present invention.

### DESCRIPTION OF EMBODIMENTS

Hereinafter, an embodiment according to the present invention will be described with reference to drawings.

In this embodiment, the collection of barrier-free information is taken as an example, and a mechanism for collecting post information which is information determined posted by users who are participating in the task of the information collection work and posted by the users and sensing information which is information detected by sensors mounted on moving bodies that are not participating in the task may be realized.

For example, information related to a link corresponding to a sidewalk is posted by a user who is participating in the task.

In this embodiment, when a moving body that is not participating in the task moves, the condition of the road surface is estimated based on the sensing information from the sensor attached to the moving body, and the estimation result is associated with the link corresponding to each sidewalk and stored in the storage device, and based on the accumulated results, probable information on the road surface condition can be obtained.

Furthermore, when there is post information related to the link, the information and the sensing information are combined to evaluate the certainty of the road surface condition. When the result of this evaluation indicates a plausible road surface condition, the road surface condition related to the above link is confirmed.

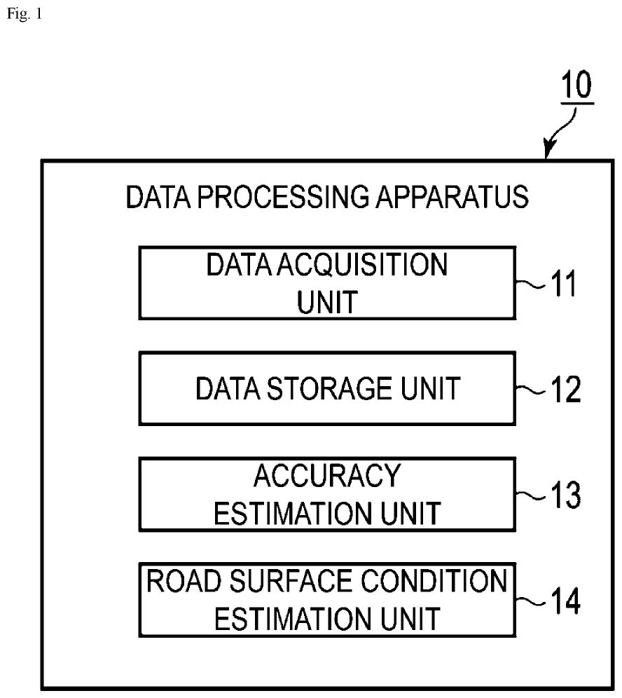

Next, a specific example of the processing according to the present embodiment will be described. FIG. 1 is a diagram illustrating an application example of a data processing apparatus according to an embodiment of the present invention.

As illustrated in FIG. 1, the data processing apparatus 10 according to the embodiment of the present invention is an estimation apparatus including a data acquisition unit 11, a data storage unit 12, an accuracy estimation unit 13, and a road surface condition estimation unit 14. Operations of each unit and the like will be described below.

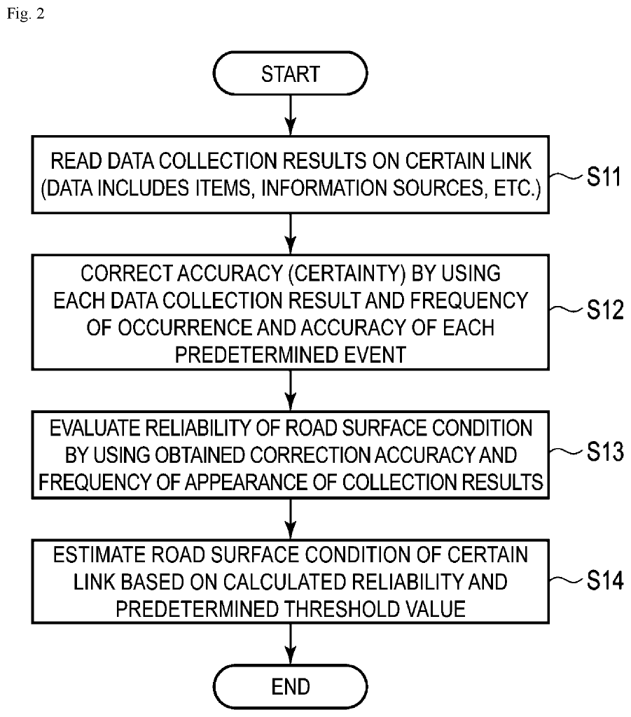

FIG. 2 is a flow chart illustrating an example of operation by the data processing apparatus. Here, suppose that post information and sensing information on a certain link are stored in the data storage unit 12.

The data acquisition unit 11 acquires the stored information (S11).
The accuracy estimation unit 13 corrects the accuracy using the data acquired at S11, the frequency of the occurrence of information related to each predetermined event, and the accuracy of the information related to each event (S12).
The road surface condition estimation unit 14 evaluates (calculates) the reliability of the road surface condition of the link by using the accuracy corrected at S12 and the accuracy of the occurrence of information related to each event described above (S13).
The road surface condition estimation unit 14 estimates the road surface condition of the link, based on the reliability evaluated at S13 and a predetermined threshold value (S14).

Next, evaluation of the reliability described above will be described. The data processing apparatus 10 evaluates the reliability, which is the certainty of the information indicating the condition of the road surface system, by using the harmonic mean of the accuracy in the post information from the users and the accuracy in the sensing information.

Here, suppose that the preconditions for evaluating the reliability are (1) to (3) below.

(1) Event A is designated as “a: there is a barrier θ”. Event B is designated as “b: there is no barrier θ”.
(2) The probability that event A will occur at a location is designated as P_{A}, and the probability that event B will occur at the location described above is designated as P_{B}.
(3) At a location where event A occurs, the probability that “a: there is a barrier θ” corresponding to event A described above is detected from at least one of the post information and the sensing information related to the location is designated as p_{A} (a). At a location where event A occurs, the probability that “b: there is no barrier θ” corresponding to event B described above is detected from at least one of the post information and the sensing information related to the location is designated as p_{A} (b).

At a location where event B occurs, the probability that “a: there is a barrier θ” corresponding to event A described above is detected from at least one of the post information and the sensing information related to the location is designated as p_{B} (a). At a location where event B occurs, the probability that “b: there is no barrier θ” corresponding to event B described above is detected from at least one of the post information and the sensing information related to the location is designated as p_{B}(b).

Equation (1) below holds for p_{A}(a) and p_{A}(b) described.

p_{A}(a)+p_{A}(b)=1 Equation (1)

Equation (2) below holds for p_{B}(a) and p_{B}(b).

p_{B}(a)+p_{B}(b)=1 Equation (2)

Under the above preconditions, suppose that among n people in a certain location, the number of people corresponding to the number of information indicating that event A has occurred at this location is r people. Here, the information is information that combines the post information and the sensing information. At this time, the probability Q (A) that event A actually occurs at the location as the reliability is obtained by Equation (3) below by Bayes' theorem.

$$\begin{matrix}[ Math . 1 ] & \\ Q ( A ) = \frac{{P}_{A} ( \begin{matrix}n \\ r\end{matrix} ) {{p}_{A} ( a )}^{r} {{p}_{A} ( b )}^{n - r}}{{\sum }_{i ∈ \{ A , B \}} {P}_{i} ( \begin{matrix}n \\ r\end{matrix} ) {{p}_{i} ( a )}^{r} {{p}_{i} ( b )}^{n - r}} & Equation ( 3 )\end{matrix}$$

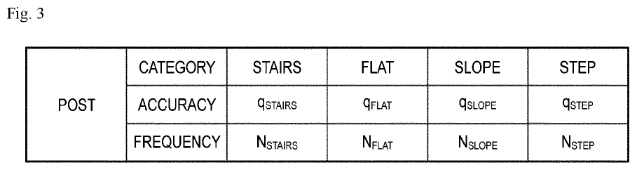

FIG. 3 is a diagram illustrating an example of accuracy and frequency of post information by category in a table format. The accuracy is set for each post information, and is, for example, a value in the range of 0 to 1. The frequency corresponds to the number of pieces of post information, that is, the number of users who have posted the information at a certain location.

In FIG. 3, the accuracy qₛₜₐᵢᵣₛ of the post information related to the stairs on the link of interest, the accuracy q_{flat} of the post information related to the flat portion on the link, the accuracy qₛₗₒₚₑ of the post information related to the slope on the link, and the accuracy qₛₜₑₚ of the post information related to the step portion on the link are indicated.
In FIG. 3, the frequency Nₛₜₐᵢᵣₛ of the post information related to the stairs described above, the frequency N_{flat} of the post information related to the flat portion described above, the frequency Nₛₗₒₚₑ of the post information on the slope described above, and the frequency Nₛₜₑₚ of the post information on the step portion described above are indicated.

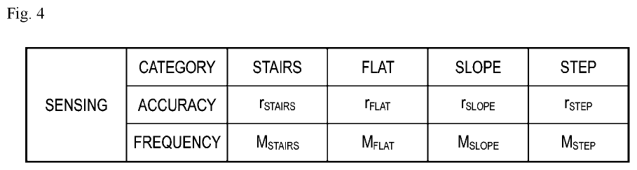

FIG. 4 is a diagram illustrating an example of accuracy and frequency of sensing information by category in a table format. The accuracy is set for each sensing information, and the range of values for accuracy is 0 to 1. The frequency corresponds to the number of sensing information.

In FIG. 4, the accuracy rₛₜₐᵢᵣₛ of the sensing information related to the stairs on the link of interest described above, the accuracy r_{flat} of the sensing information related to the flat portion on the link, the accuracy rₛₗₒₚₑ of the sensing information related to the slope on the link, and the accuracy qₛₜₑₚ of the sensing information related to the step portion on the link are indicated.
In FIG. 4, the frequency Nₛₜₐᵢᵣₛ of the sensing information related to the stairs described above, the frequency N_{flat} of the sensing information on the flat portion described above, the frequency Nₛₗₒₚₑ of the sensing information on the slope described above, and the frequency Nₛₜₑₚ of the sensing information on the step portion described above are indicated.

Here, the entire event is designated as Ω, the event in which there are stairs on the link of interest is designated as event A, and the event in which there is a flat portion, a slope, or a step portion other than stairs on the link is designated as event B(=Ω−A).

When the frequency of the post information related to event A is designated as N_{A}, the frequency of the sensing information related to event A is designated as M_{A}, the accuracy of the post information related to event A is designated as q_{A}, and the accuracy of sensing information related event A is designated as r_{A}, at the location (link) where event A occurs, the probability p_{A}(a) that the above a corresponding to event A is detected from at least one of the post information and the sensing information related to the location is expressed by Equation (4) below. The probability p_{A}(b) that the above b corresponding to event B is detected from at least one of the post information and the sensing information related to the location at the location where event A occurs is expressed by Equation (5) below.

p_{A}(a)=(N_{A}+M_{A})/(N_{A}/q_{A}+M_{A}/r_{A}) Equation (4)

p_{A}(b)=1−p_{A}(a) Equation (5)

When i∈Ω−A, and when the frequency of the post information related to event i is designated as Nᵢ, the frequency of the sensing information related to event i is designated as Mᵢ, the accuracy of the post information related to event i is designated as qᵢ, and the accuracy of the sensing information related to event i is designated as rᵢ, at the location where event B occurs, the probability p_{B}(b) that the above b is detected from at least one of the post information and the sensing information related to the location is expressed by Equation (6) below. At the location where event B occurs, the probability p_{B}(a) that the above a is detected from at least one of the post information and the sensing information related to the location is expressed by Equation (7) below.

p_{B}(b)=(ΣNᵢ+ΣMᵢ)/(ΣNᵢ/qᵢ+ΣMᵢ/rᵢ) Equation (6)

p_{B}(a)=1−p_{B}(b) Equation (7)

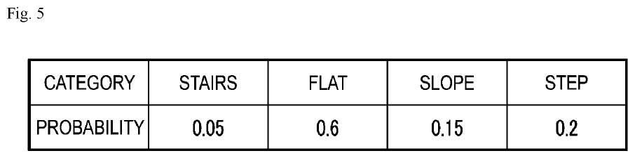

FIG. 5 is a diagram illustrating an example of a probability of occurrence of each event in a table format.

The probability P_{A} that event A occurs on the link of interest described above and the probability P_{B} that event B occurs on the link (where, P_{A}+P_{B}=1) are constants. FIG. 5 illustrates an example of the probability P_{A} given in advance.
FIG. 5 illustrates that, when the overall probability is 1, on a certain link, the probability that there are stairs is 0.05, the probability that there is a flat portion is 0.6, the probability that there is a slope is 0.15, and the probability that there is a step portion is 0.2.
In the example illustrated in FIG. 5, when the event that there are stairs on the link is designated as event A, P_{A}=0.05, so P_{B}=0.95(=1−0.05).

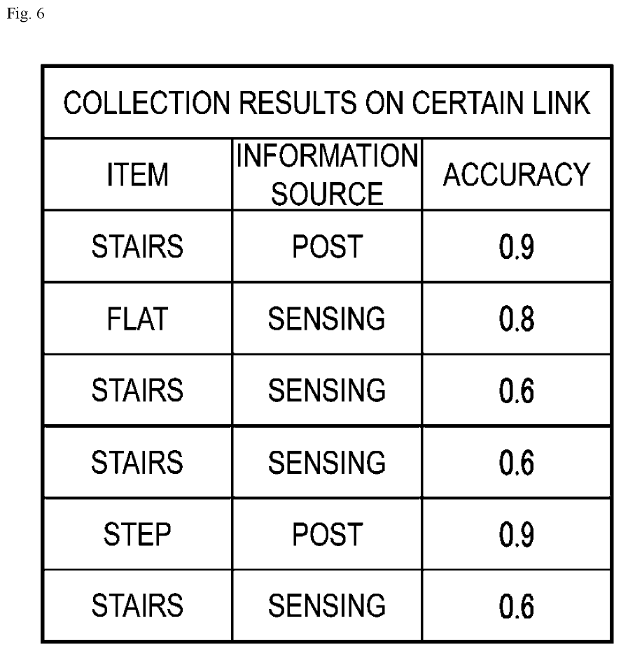

Next, an example of calculating the reliability in focusing on the stairs will be described. FIG. 6 is a diagram illustrating an example of collection results of information related to a link in a table format.

In the example illustrated in FIG. 6, the following (1) to (4) are illustrated as the collection results of information in a certain link. The post information and the sensing information include position information indicating the place of the occurrence of the event, and the information illustrated in FIG. 6 is information including the position information related to the same link.

(1) The accuracy which is the certainty of one piece of post information related to the stairs in a certain link is 0.9. This accuracy corresponds to qₛₜₐᵢᵣₛ illustrated in FIG. 3.

(2) The accuracy of one piece of sensing information related to the flat portion in the link described above is 0.8. This accuracy corresponds to r_{flat} illustrated in FIG. 4.
(3) The accuracy of three pieces of sensing information related to the stairs in the link described above is 0.6. This accuracy corresponds to rₛₜₐᵢᵣₛ illustrated in FIG. 4.
(4) The accuracy of one piece of post information related to the step portion in the link described is 0.9. This accuracy corresponds to qₛₜₑₚ illustrated in FIG. 3.

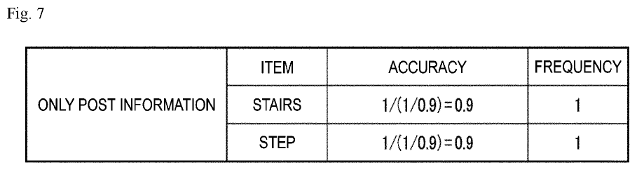

FIG. 7 is a diagram illustrating an example of correction of accuracy based on post information in collection results related to a link in a table format.

As a first pattern of correction of accuracy, the example illustrated in FIG. 7 is an example when an event that there are stairs on the link is designated as event A. At this time, the accuracy estimation unit 13 obtains the corrected accuracy (=0.9=p_{A}(a)) by substituting the accuracy (=0.9=q_{A}) and frequency (=1=N_{A}) of the post information related to the stairs among the collection results illustrated in FIG. 6, into Equation (4) for obtaining the above p_{A}(a).

The example illustrated in FIG. 7 is an example in which the event that there is other than stairs on the link, here the event that there is a step portion, is designated as event i above for the post information. At this time, the accuracy estimation unit 13 obtains the corrected accuracy (=0.9=p_{B}(b)) by substituting the accuracy (=0.9=qᵢ) and frequency (=1=Nᵢ) of the post information related to the step among the collection results illustrated in FIG. 6, into Equation (6) for obtaining the above p_{B}(b). As illustrated in FIG. 7, in the calculation using only the post information, the accuracy before and after the correction is the same.

Then, based on the above calculation result and Equation (3) above for obtaining Q(A), the road surface condition estimation unit 14 obtains the reliability of the stairs, that is, the probability that there are actually stairs (=0.05).

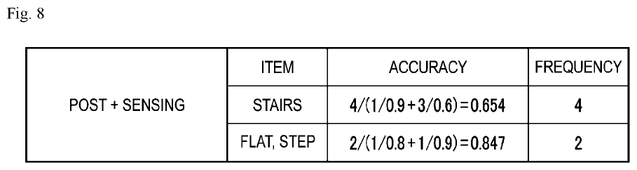

FIG. 8 is a diagram illustrating an example of correction of accuracy based on post information and sensing information in collection results related to a link in a table format.

As a second pattern of correction of accuracy, the example illustrated in FIG. 8 is an example when an event that there are stairs on the link is designated as event A. At this time, the accuracy estimation unit 13 obtains the corrected accuracy (=0.654) by substituting the accuracy (=0.9) and frequency (=1) of the post information related to the stairs, and the accuracy (=0.6) and frequency (=3) of the sensing information related to the stairs among the collection results illustrated in FIG. 6, into Equation (4) for obtaining the above p_{A}(a).

The example illustrated in FIG. 8 is an example in which the event that there is other than stairs on the link, here the event that there is a flat portion and a step portion, is designated as event i above for the post information and the sensing information. At this time, the accuracy estimation unit 13 obtains the corrected accuracy (=0.847) by substituting the accuracy (=0.8) and frequency (=1) of the sensing information related to the flat portion and the accuracy (=0.9) and frequency (=1) of the post information related to the step portion among the collection results illustrated in FIG. 6, into Equation (6) for obtaining the above p_{B}(b).

Then, based on the above calculation result and Equation (3) above for obtaining Q(A), the road surface condition estimation unit 14 obtains the reliability of the stairs (˜0.746).

In this reliability calculation, when the number of post information and sensing information related to the stairs being 4 is r in Equation (3), and the number of post information and sensing information related to the flat portion and the step portion being 2 is n−r in Equation (3), the road surface condition estimation unit 14 can obtain the reliability by the calculation expressed by Equation (8) below.

$$0.05 \times 15 \times 0.654 \hat{} 4 \times 0.346 \hat{} 2 \div ( 0.05 \times 15 \times 0.654 \hat{} 4 \times 0.346 \hat{} 2 + 0.95 \times 15 \times 0.153 \hat{} 4 \times 0.847 \hat{} 2 ) \approx 0.0164 \div ( 0.0164 + 0.0056 ) \approx 0.746 \qquad Equation ( 8 )$$

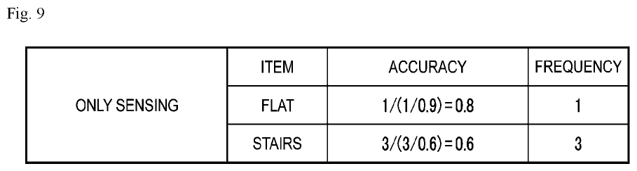

FIG. 9 is a diagram illustrating an example of correction of accuracy based on sensing information in collection results related to a link in a table format.

As a third pattern of accuracy correction, the example illustrated in FIG. 9 is an example in which the event that there is other than stairs on the link, here the event that there is a flat portion, is designated as event i above for the sensing information. At this time, the accuracy estimation unit 13 obtains the corrected accuracy (=0.8) by substituting the accuracy (=0.8) and frequency (=1) of the sensing information related to the flat portion among the collection results illustrated in FIG. 6, into Equation (4) for obtaining the above p_{A}(a).

The example illustrated in FIG. 9 is an example in which the event that there are stairs on the link is designated as event A for the sensing information. At this time, the accuracy estimation unit 13 obtains the corrected accuracy (=0.6) by substituting the accuracy (=0.6) and frequency (=3) of the sensing information related to the stairs among the collection results illustrated in FIG. 6, into Equation (6) for obtaining the above p_{B}(b). As illustrated in FIG. 9, in the calculation using only the sensing information, the accuracy before and after the correction is the same.

Then, based on the above calculation result and Equation (3) above for obtaining Q(A), the road surface condition estimation unit 14 obtains the reliability of the stairs (˜0.41).

The road surface condition estimation unit 14 determines a value exceeding a predetermined threshold value, here, an event in which the reliability value of the stairs is 0.746 illustrated in FIG. 8, that is, an event that stairs exist on the link, as the road surface condition related to the link described above, of the reliability related to the stairs obtained by the above three patterns.

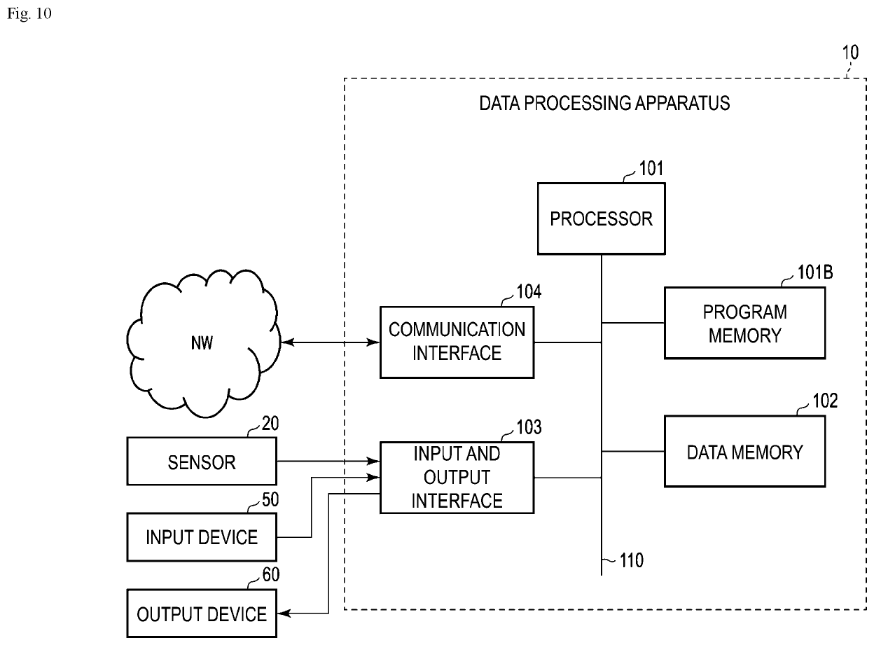

FIG. 10 is a block diagram illustrating an example of a hardware configuration of the data processing apparatus according to an embodiment of the present invention.

In the example illustrated in FIG. 10, the data processing apparatus 10 according to the embodiment described above is constituted by a server computer or a personal computer, for example, and has a hardware processor 101 such as a CPU. Further, a program memory 101B, a data memory 102, an input and output interface 103, and a communication interface 104 are connected to the hardware processor 101 via a bus 110.

The communication interface 104 includes, for example, one or more wireless communication interface units to allow transmission/reception of information to/from a communication network NW. As the wireless interface, for example, an interface adopting a small power wireless data communication standard such as a wireless local area network (LAN) is used. The communication interface 104 can receive sensing information detected by an external sensor.

An input device 50 and an output device 60 for the operator additionally provided for the data processing apparatus 10 are connected to the input and output interface 103. The input and output interface 103 performs processing of taking operation data input by the operator through the input device 50 such as a keyboard, a touch panel, a touchpad, or a mouse and outputting the output data to the output device 60 including a display device using liquid crystal or organic electro luminescence (EL) and causing the output device 60 to display the output data.

Note that as the input device 50 and the output device 60, a device built into the data processing apparatus 10 may be used, or an input device and an output device of another information terminal communicable with the data processing apparatus 10 via the network NW may be used.

For the program memory 101B, a non-volatile memory that always allows writing and reading, such as a hard disk drive (HDD) or a solid state drive (SSD) and a non-volatile memory such as a read only memory (ROM), for example, are used in combination as a non-transitory tangible storage medium, and a program necessary to execute various kinds of control processing according to the embodiment is stored therein.

For the data memory 102, for example, the aforementioned non-volatile memory and a volatile memory such as a random access memory (RAM) are used in combination as a tangible storage medium, and the data memory 102 is used to store various kinds of data acquired and created in the process of performing various kinds of processing.

The data processing apparatus 10 according to the embodiment of the present invention can be configured as a data processing apparatus including a data acquisition unit 11, an accuracy estimation unit 13, and a road surface condition estimation unit 14 illustrated in FIG. 1 as processing function units by software.

The data storage unit 12, various data storage regions, and various data processing regions in the data processing apparatus 10 can be configured by using the data memory 102 illustrated in FIG. 10. However, these regions are not essential configurations in the data processing apparatus 10 and may be regions provided in a storage device such as an external storage medium such as a universal serial bus (USB) memory or a database server or the like located in a cloud, for example.

The processing function units in each of the data acquisition unit 11, the accuracy estimation unit 13, and the road surface condition estimation unit 14 described above can be implemented by causing the aforementioned hardware processor 101 to read and execute the program stored in the program memory 101B. Note that some or all of the processing function units may be implemented by other various methods including an integrated circuit such as an application specific integrated circuit (ASIC) or a field-programmable gate array (FPGA).

As described above, in one embodiment of the present invention, by the accuracy of indicating the certainty of the information being corrected based on both the post information related to the event and the sensing information, it is possible to appropriately estimate that a predetermined event is actually occurring.

A method described in each embodiment can be stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like), for example, and can be transferred and distributed by a communication medium, as a program (a software means) that a computing device (computer) can be caused to execute. Note that the program stored on the medium side includes a setting program for configuring, in a computing device, a software means (including not only an execution program but also a table and a data structure) to be executed by the computing device. The computing device in which the present apparatus is implemented executes the aforementioned processing by reading the program recorded in the recording medium, constructing the software means using the setting program in some cases, and causing the software means to control operations. Note that the recording medium mentioned in the present specification is not limited to a recording medium for distribution but includes a storage medium such as a magnetic disk and a semiconductor memory provided inside the computing device or a device connected via a network.

Note that the present invention is not limited to the aforementioned embodiments but can be variously modified in the implementation stage without departing from the gist of the present invention. An appropriate combination of the embodiments can also be implemented, in which a combination of their effects can be obtained. Further, the above embodiments include various inventions, which can be designed by combining constituent elements selected from a plurality of constituent elements disclosed here. For example, a configuration in which some constituent elements are removed from all the constituent elements illustrated in the embodiments can be designed as an invention if the problems can be solved and the effects can be achieved.

### REFERENCE SIGNS LIST

10 Data processing apparatus

11 Data acquisition unit

12 Data storage unit

13 Accuracy estimation unit

14 Road surface condition estimation unit

1. An estimation apparatus comprising:
a processor; and
a storage medium having computer program instructions stored thereon, when executed by the processor, perform to:
acquire first information indicating that an event is occurring at a location, along with a type of the event, second information indicating whether the first information is third information determined by a user or fourth information detected by a sensor, and accuracy indicating certainty of the third or furth information;
estimate a probability that a predetermined event is actually occurring, based on accuracy of the third information determined by the user, a frequency of occurrence of the third information, accuracy of the fourth information detected by the sensor, and a frequency of occurrence of the fourth information; and
estimate whether or not the predetermined event is actually occurring based on the probability and a threshold value.

2. The estimation apparatus according to claim 1, wherein
the event indicates a condition of a road surface, and wherein the computer program instructions further perform to
estimates whether or not the predetermined event is actually occurring on the road surface, based on the probability and the threshold value.

3. The estimation apparatus according to claim 1, wherein the computer program instructions further perform to
extracts fifth information indicating that the predetermined event is occurring from the first information, and identify the accuracy of the third information determined by the user, the frequency of occurrence of the third information, the accuracy of the fourth information detected by the sensor, and the frequency of occurrence of the fourth information in the fifth information extracted,
calculates a first probability that the user determines that the predetermined event occurs at the location where the predetermined event occurs, based on identified results;
extracts sixth information indicating that an event other than the predetermined event is occurring from the first information, and identifies the accuracy of the third information determined by the user, the frequency of occurrence of the third information, the accuracy of the fourth information detected by the sensor, and the frequency of occurrence of the fourth information in the sixth information extracted;
calculates a second probability that the user determines that an event other than the particular event occurs at a location where an event other than the particular event occurs, based on identified results; and
estimates a probability that the predetermined event is actually occurring, based on the first and second probabilities.

4. An estimation method performed by an estimation apparatus, the estimation method comprising:
acquiring first information indicating that an event is occurring at a location, along with a type of the event, second information indicating whether the first information is third information determined by a user or fourth information detected by a sensor, and accuracy indicating certainty of the third or fourth information;
estimating a probability that a predetermined event is actually occurring, based on accuracy of the third information determined by the user, a frequency of occurrence of the third information, accuracy of the fourth information detected by the sensor, and a frequency of occurrence of the fourth information acquired; and
estimating whether or not the predetermined event is actually occurring based on the probability estimated and a threshold value.

5. A non-transitory computer-readable medium having computer-executable instructions that, upon execution of the instructions by a processor of a computer, cause the computer to function as the estimation apparatus described in claim 1.
